(19) United States
(12) Patent Application Publication
(10) Pub. No.: US 2002/0126694 A1
(43) Pub. Date: Sep. 12, 2002

(54) Method for performing link adaptation

(76) Inventor: Mika Kahola, Helsinki (FI)

Correspondence Address: PERMAN & GREEN, 425 POST ROAD, FAIRFIELD, CT, 06430, US

(21) Appl. No.: 10/033,451

(22) Filed: Dec. 27, 2001

(30) Foreign Application Priority Data
Dec. 28, 2000 (FI) 20002875

(51) Int. Cl. H04J 3/16

(52) U.S. Cl. 370/465

(57) ABSTRACT

The invention relates to a method for performing link adaptation in a communication system, in which two communication devices are arranged to communicate with each other in order to transmit information at least partly in a wireless manner. Packets are formed of the information to be transferred, and the packet error rate is defined. In the communication system, at least two different modulation modes can be selected for the connection. The method utilizes fuzzy control in the selection of the modulation mode, wherein at least one of the used variable is said defined packet error rate.

### TECHNICAL FIELD OF THE INVENTION

The present invention relates to a method for performing link adaptation.

### BACKGROUND OF THE INVENTION

The present invention relates to a method for performing link adaptation in which two communication devices are arranged to communicate with in order to transfer information at least partly wirelessly, packets are formed from the information to be transferred, the packet error rate is determined, and for which connection at least two different modulation modes can be selected. The invention further relates to a communication system comprising means for arranging two communication devices to communicate with each other in order to transfer packet-form information at least partly wirelessly, means for determining a packet error rate, and means for selecting for the connection a modulation mode from at least two modulation modes. The invention relates also to an access point controller comprising means for arranging the access point controller and at least one wireless terminal to communicate with each other in order to transmit packet-form information at least partly in a wireless manner, means for defining the packet error rate, and means for selecting for the connection a modulation mode from at least two modulation modes. The invention further relates to a wireless terminal comprising means for transmitting packet-form information at least partly wirelessly in a communication connection arranged between the wireless terminal and a second communication device, means for defining the packet error rate, and means for selecting for the connection a modulation mode from at least two modulation modes.

As wireless communication is constantly increasing, it will be all the more important to control the use of communication networks, so that as many communication connections as possible could be used simultaneously. On the other hand, even in view of portable communication devices, the amount of energy used for the communication should be kept as low as possible, however, in a manner that the quality of the connection is not deteriorated too much. To achieve these objects, some communication networks utilize different transmission powers and different modulation methods on the basis of the combination that can bring about an optimal result at the time. Eight different modulation modes (indexes 1 to 8) have been described to be used for example in the standard 802.11a of the Institute of Electrical and Electronics Engineers, IEEE and the standard HIPERLAN/2 of the ETSI organisation. These modulation modes and the different parameters corresponding to them have been presented in the accompanying Table 1. The modulation method used in said system is the orthogonal frequency division multiplexing (OFDM). It is known that different packet error rates (PER) can be attained with different modulation modes in situations in which the signal to interference ratio (s/i) is constant. Thus, the system should optimise the communication connection in such a manner that the transfer rate of the signal is optimal, that is, the packet error rate is as close to a predefined value as possible or lower than that, and that the transmission power is as low as possible. However, said standards leave it open how the selection is carried out.

TABLE 1

| | | | | Codes/ | Codes/ | Data bits/ |
|---|---|---|---|---|---|---|
| | | Data | Coding | low carrier | OFDM | OFDM |
| | speed | | ratio | wave | symbol | symbol |
| Index | (Mbit/s) | Modulation | (R) | (N_{BPCS}) | (N_{CBPS}) | (N_{CBPS}) |
| 1 | 6 | BPSK | 1/2 | 1 | 48 | 24 |
| 2 | 9 | BPSK | 3/4 | 1 | 48 | 36 |
| 3 | 12 | QPSK | 1/2 | 2 | 96 | 48 |
| 4 | 18 | QPSK | 3/4 | 2 | 96 | 72 |
| 5 | 24 | 16-QAM | 1/2 | 4 | 192 | 96 |
| 6 | 36 | 16-QAM | 3/4 | 4 | 192 | 144 |
| 7 | 48 | 64-QAM | 2/3 | 6 | 288 | 192 |
| 8 | 54 | 64-QAM | 3/4 | 6 | 288 | 216 |

Some communication systems utilize free frequency bands. Some fixed wireless communication networks use frequency bands that require no licences to use. These frequency bands include for example the frequency bands of 2.4 GHz and 5.8 GHz. Since no licences are required for using these frequency bands, several various communication systems can be in use in the same frequency band. Using these frequency bands puts certain demands on efficient link adaptation, because the optimisation between the robustness and the spectrum efficiency of the system must be performed in the use of the frequency bands. Such systems do not necessarily have a server that controls the system, but terminals connected to the system can together select the channel and modulation method to be used. These networks include for example the MESH networks. In such systems the meaning of efficient link adaptation is emphasized so that the communication can be performed as efficiently as possible with every connection, and that the disturbing effect of the connection to other simultaneous communication connections can be minimized.

The international patent publication WO 97/41675 presents an adaptive air interface, which can be applied in cellular communication networks. The air interface comprises various information elements having function parameters, such as the rate, the distance, the delay, the delay entropy, the bit error rate (BER), the capacity and the data rate of the wireless communication device. In the method presented in the publication the adjustment is performed by means of a machine with states, in which machine the values to be adjusted are concluded according to several variables. An example presented in the publication uses seven inputs by means of which seven outputs are controlled. Consequently, one of the disadvantages in such a system is that complex inference is required for selecting an optimal alternative at a time.

Adapting prior art control systems in link adaptation is cumbersome, for example because the system comprises many values and variables influencing the control. Consequently, it is difficult to define the accurate dependencies between the controllable values and variables, and the control algorithms can become complex.

Control systems based on fuzzy logic have been developed, in which a variable affecting the control and an adjustable starting value, as well as the dependency between these two, can have more alternative values than in traditional systems. For example in the power control, the selectable power values can be positive small, positive medium and positive large, wherein the values of the parameters influencing the power control determines which starting power is selected. In order to implement fuzzy control, fuzzy rules, if-then rules are formulated. These fuzzy rules define how the value of linguistic variables affects the control at a given time. In the implementation of the fuzzy control system the linguistic variables and rules are yet to be converted to a form appropriate for the control system, which is called defuzzification. In defuzzification, fuzzy sets are formed which comprise alternative values defined for the linguistic variable. For example in said example of the power control, the power values can be set for example in such a manner that the positive small power is approximately 0.2 W, the positive medium power is approximately 0.5 W, and the positive large power is approximately 1 W.

### SUMMARY OF THE INVENTION

It is an aim of the present invention to provide a method for implementing link adaptation in a communication system, and a communication system in which fuzzy logic is used in the implementation of the link adaptation. The invention is based on an idea that a set of fuzzy logic rules is formulated in such a manner that the packet error rate and the change rate of the packet error rate are used as values influencing the control. Thus, the modulation mode and the transmission power control are selected in accordance with the rules of fuzzy logic. More precisely, the method according to the invention is primarily characterized in that the method uses fuzzy control in the selection of the modulation mode, and that at least one of the variables used in fuzzy control is said defined packet error rate. The communication system according to the invention is primarily characterized in that the communication system comprises means for using fuzzy control in the selection of the modulation mode, and that at least one variable arranged to be used in fuzzy control is the packet error rate. The access point controller according to the invention is primarily characterized in that the access point controller comprises means for using fuzzy control in the selection of the modulation mode, and that in fuzzy control at least one variable that is arranged to be used is said defined packet error rate. Further, the wireless communication device according to the invention is primarily characterized in that the wireless terminal comprises means for using fuzzy control in the selection of the modulation mode, and that in fuzzy control at least one variable that is arranged to be used is said defined packet error rate.

An aim of the method according to a preferred embodiment of the invention is to adjust the packet error rate to a predefined target value. The packet error rate does not necessarily remain below this target value, but it can vary slightly on both sides of the target value. Nevertheless, in practice simulations have proved that the packet error rate remains adequately below the target value.

The present invention shows remarkable advantages compared to solutions of prior art. In the method according to a preferred embodiment of the invention, the modulation mode and the transmission power level are used as the controllable values. In this control, the fuzzy logic is utilized, wherein the control system can better handle the variable changes affecting the controls compared to conventional control systems based on binary logic. When applying fuzzy logic in the link adaptation, it is possible to select each time a modulation method that is as optimal as possible and thus achieve the best possible data rate with the lowest possible power and still keep the packet error rate close to the predefined limit. Thus, the power used in the communication system is not unnecessarily high, which for example reduces the noises directed to other radio devices, and several radio devices can also operate simultaneously in the same area. The method according to the invention can also be used for reducing the power consumption, because the transmission power used is not unnecessarily high and also because the data signalling rate used is always as high as possible, wherein the information can be transmitted as fast as possible.

### DESCRIPTION OF THE DRAWINGS

In the following, the present invention will be described in more detail with reference to the appended drawings, in which

FIG. 1a illustrates the fuzzy control values of the packet error rate used in connection with a preferred embodiment of the method according to the invention,

FIG. 1b illustrates the fuzzy control values of the packet error rate change used in connection with a preferred embodiment of the method according to the invention,

FIG. 2 illustrates an example where a true packet error rate is converted to a corresponding fuzzy control value,

FIG. 3a shows the method according to a preferred embodiment of the invention in a flow chart,

FIG. 3b shows the method according to another preferred embodiment of the invention in a flow chart,

FIG. 4 shows the communication system according to a preferred embodiment of the invention in a reduced block chart,

FIG. 5a shows the wireless terminal according to a preferred embodiment of the invention in a reduced block chart, and

FIG. 5b shows the access point according to a preferred embodiment of the invention in a reduced block chart.

### DETAILED DESCRIPTION OF THE INVENTION

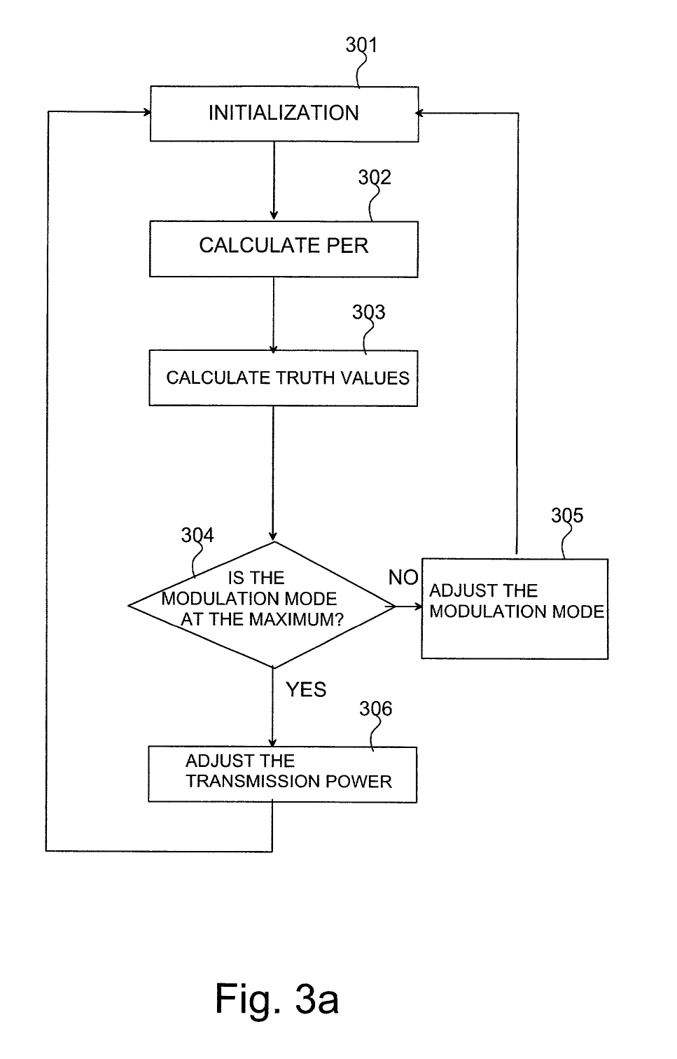

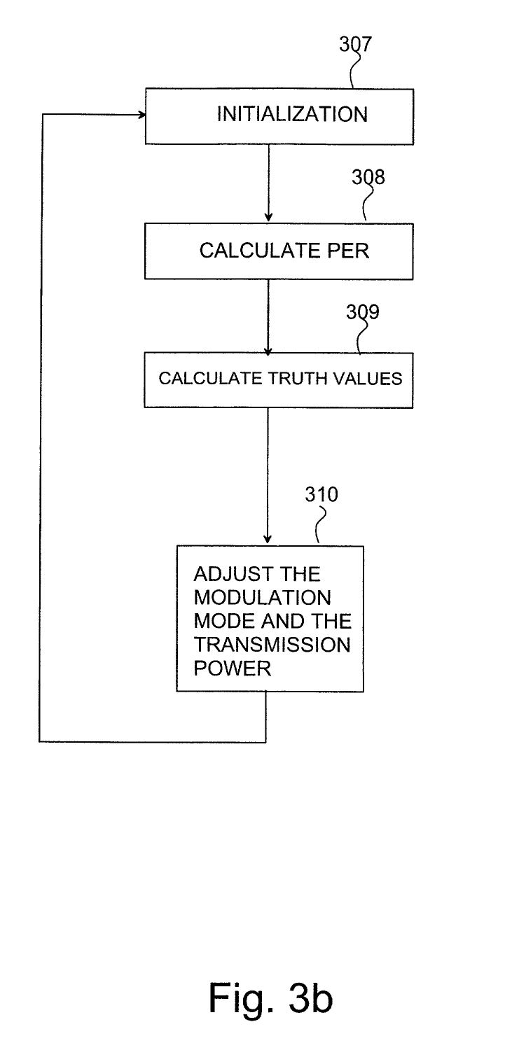

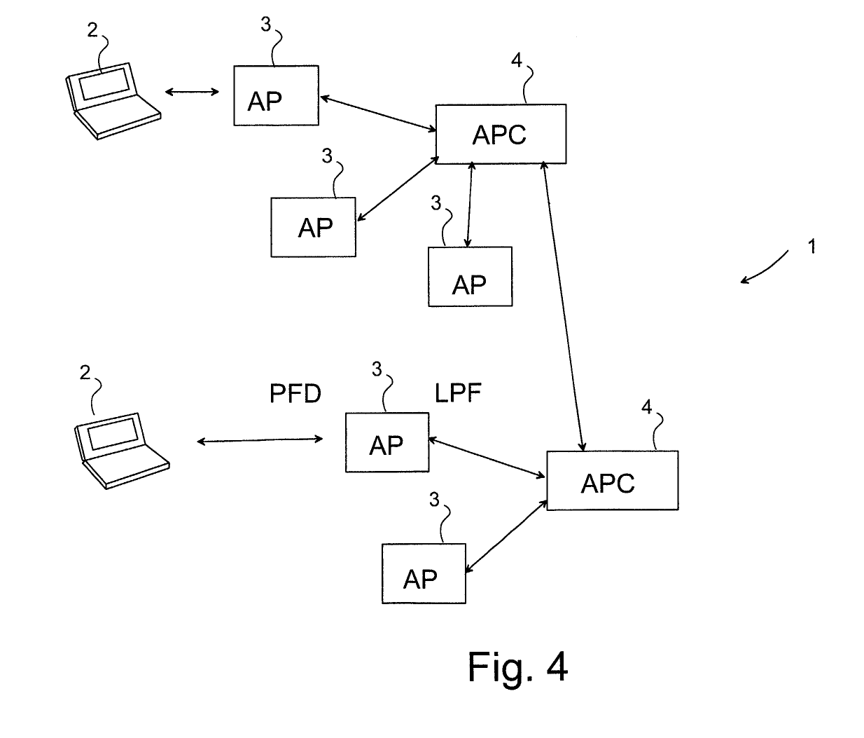

In the following, the method according to the first preferred embodiment of the invention will be described in more detail with reference for example to the communication system shown in FIG. 4. To exemplify the communication system 1 a system according to the HIPERLAN/2 standard is used, but it is obvious that the invention can be adapted also in other types of communication systems. It is presumed that the communication system 1 can utilize the modulation modes illustrated in the above-described Table 1. Thus, in the communication between the wireless terminal 2 and the communication system 1 one of these selectable modulation modes is selected at a time. The modulation mode is selected for example in the connection set up and, if necessary, the modulation mode can be changed also during the connection if the conditions have changed to the extent that the packet error rate has changed to a significant degree. To set up a connection, the wireless terminal 2 and the connection system 1 communicate advantageously through access points 3. Each access point 3 is controlled by an access point controller 4. However, more than one access points 3 can be controlled by the same access point controller 4. When the connection set up is initiated, the modulation mode is selected among a set of selectable modulation modes. This selection can be performed for example in such a manner that one modulation mode is selected as the default modulation mode, wherein it is selected at beginning of the connection. On the other hand, the selection of the modulation mode can be based on the modulation mode used in other wireless terminals 2 that are simultaneously connected with said access point 3. In this latter alternative, it is presumed that the conditions are approximately the same to all the wireless terminals 2 connected with the access point 3. In the method according to a preferred embodiment of the invention, the transmission power is, however, set at the connection set up preferably to the highest allowed value regardless of the selected modulation mode. This is done so that the modulation mode could be selected as soon as possible. After an appropriate modulation mode has been selected, the transmission power is set to an appropriate level, as presented later in this description. This initialisation phase is illustrated in the flow chart of FIG. 3 by block 301.

After the initialisation phase 301, in the method according to a preferred embodiment of the invention, the packet error rate is defined which corresponds to the selected modulation mode (block 302) at the phase when a sufficient amount of packets have been received, for example approximately n packets. This packet error rate PER is affected for example by the modulation mode and the transmission power used, and the noise level, which can be influenced for example by other nearby radio devices (interference), and communication losses. Subsequently, the variables and the controllable values necessary in fuzzy control are defined on the basis of the defined packet error rate PER (block 303).

In the method according to a preferred embodiment of the invention, the modulation mode and the transmission power level are used as the controlled values. In order to implement the control system based on fuzzy logic, the variables affecting the control of the system are defined. In the method according to a preferred embodiment of the invention, the variables selected are the packet error rate PER and the change rate of the packet error rate PERdt. The change rate of the packet error rate PERdt is the derivative of the packet error rate describing the stability of the packet error rate. The change rate of the packet error rate can be zero or close to zero also in a situation in which the true packet error rate is far from the target value of the packet error rate. Thus, the change rate of the packet error rate defines only indirectly how much the true packet error rate differs from the target value of the packet error rate, because when the packet error rate differs from the target value, the modulation is very likely to change and, at the same time, the change of the packet error rate is likely to be different from zero. To remove instability from the control system, an attempt is made to keep the changes of the modulation relatively small, particularly when the packet error rate is close to the target value of the packet error rate.

The packet error rate PER is calculated advantageously after n pieces of packets have been received and/or when the data rate or the transmission power changes. In addition to said variables, the fuzzy rules, that is, the so-called “if-when” rules, have to be defined. With these fuzzy rules, the selected variables are connected to each other in such a manner that an adjustment value is obtained for controlling the desired controllable value, in this example in order to change the modulation mode and/or the transmission power. To implement this, fuzzy sets are defined for the variables advantageously in such a manner that the first fuzzy set is composed of the values selected for the first variable, which in this case means different values selected for the packet error rates PER. Correspondingly, the second fuzzy set is composed of the values selected for the second variable PERdt. The accompanying Table 2 exemplifies the dependency between the fuzzy sets and the fuzzy rules in the system according to a preferred embodiment of the invention. In this embodiment the fuzzy sets comprise seven different elements, but it is obvious that the invention can also be applied in other types of fuzzy sets. Practical experiences have indicated that fuzzy control can usually be adequately implemented with a set of seven elements. The larger the fuzzy set, the more easily the control will be unstable. In practice it has been discovered that the control will usually be sufficiently stable with said set of seven elements.

TABLE 2

| | PER | | | | | | | |
|---|---|---|---|---|---|---|---|---|
| PERdt | | NL | NM | NS | Z | PS | PM | PL |
| | NL | P_6 | P_5 | P_4 | P_3 | P_2 | P_1 | N |
| | NM | P_5 | P_4 | P_3 | P_2 | P_1 | N | N_1 |
| | NS | P_4 | P_3 | P_2 | P_1 | N | N_1 | N_2 |
| | Z | P_3 | P_2 | P_1 | N | N_1 | N_2 | N_3 |
| | PS | P_2 | P_1 | N | N_1 | N_2 | N_3 | N_4 |
| | PM | P_1 | N | N_1 | N_2 | N_3 | N_4 | N_5 |
| | PL | N | N_1 | N_2 | N_3 | N_4 | N_5 | N_6 |

The variables PER, PERdt can have the values positive large PL, positive medium PM, positive small PS, negligible Z, not small NS, not medium NM, and not large NL. In the present example, the fuzzy rules can have the values N_{—}6 to P_{—}6 depending on the values of the variables PER, PERdt at the time. These fuzzy rules define how much the index of the modulation mode will be changed. For example, if the packet error rate PER has the value positive large (PL) and the change rate of the packet error rate PERdt is positive small (PS), the change in the index of the modulation mode will then have the value N_{—}4. On the basis of the fuzzy rules described in Table 2 it can be noted for example that the smaller the packet error rate PER, the larger the data transmission rate and the modulation mode can be, wherein the values of the elements increase from right to left on the horizontal rows of Table 2. Correspondingly, the change rate of the packet error rate PERdt usually denotes how far the true packet error rate is from the wished packet error rate, wherein the smaller the change rate of the packet error rate, the larger the modulation mode can be, wherein the values of the elements decrease from top to bottom.

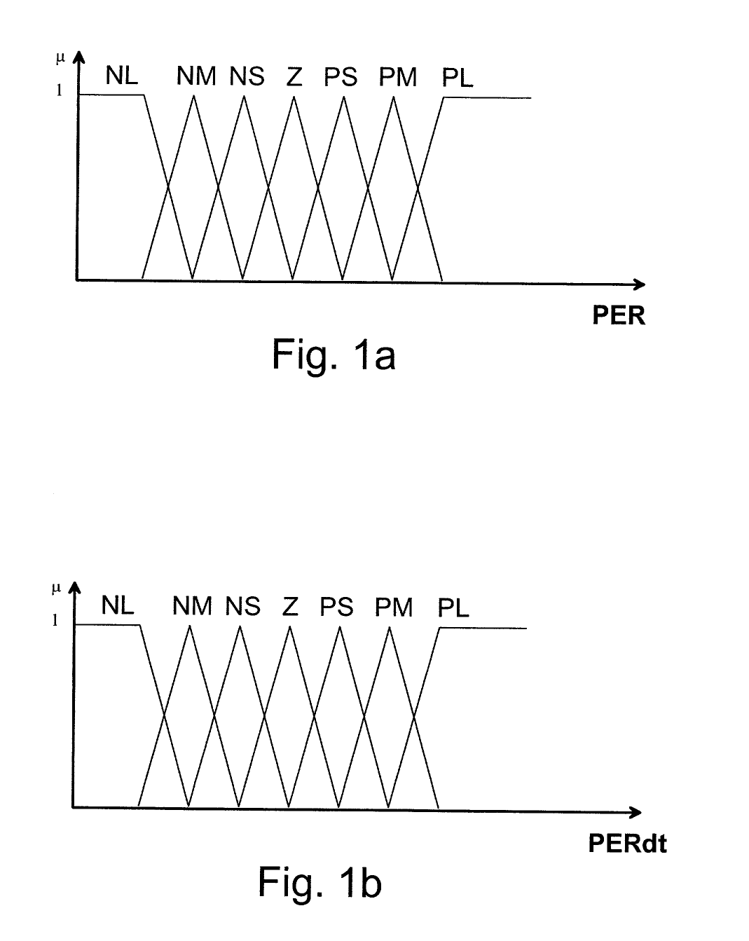

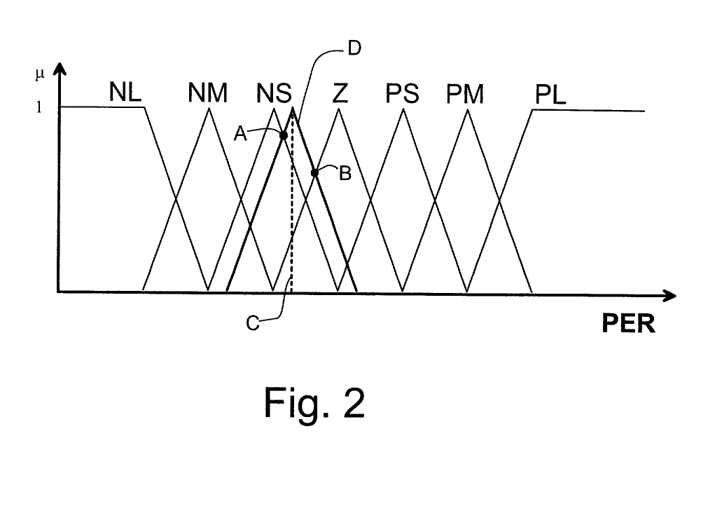

After having been formulated, the fuzzy rules must be converted to apply to a real system. When a fuzzy set is matched, its elements are replaced by numbers, that is, by centroid values. Table 3 shows centroid values selected to the packet error rate in the method according to a preferred embodiment of the invention. In a corresponding manner, Table 4 shows centroid values selected for the change rate of the packet error rate. Typically an element of the fuzzy set is defined as a triangle that is substantially isosceles in relation to the centroid of the element. This triangle indicates a truth value μ. The truth value μ can have values 0 to 1, wherein the base of the triangle has the value μ=0, and the centroid has the value μ=1. Thus, for example the packet error rate PER obtains the set of curves shown in the accompanying FIG. 1a. The set of curves has been formulated by applying the centroid values selected to the packet error rate in accordance with Table 3. In a corresponding manner, FIG. 1b shows a set of curves formulated according to Table 4 for the change rate of the packet error rate. In this example, the centroids have been selected at regular spaces, wherein the triangulars are of the same size, but the centroid values can be selected also in such a manner that some points have a more accurate or a more approximate adjustment than some other points. Thus, the differences in the centroid values are at such points correspondingly either smaller or larger. It is obvious that the numerical values are in this context presented only to clarify the invention, not to limit the scope of the invention.

TABLE 3

| PER | NL | NM | NS | Z | PS | PM | PL |
|---|---|---|---|---|---|---|---|
| μ = 1 | 0.07 | 0.08 | 0.09 | 0.10 | 0.11 | 0.12 | 0.13 |

TABLE 4

| PERdt | NL | NM | NS | Z | PS | PM | PL |
|---|---|---|---|---|---|---|---|
| μ = 1 | −0.006 | −0.004 | −0.002 | 0 | 0.002 | 0.004 | 0.006 |

A so-called overlap ratio can be calculated from Tables 3 and 4, which overlap ratio illustrates how smoothly the control system operates. The larger the overlap ratio, the smoother control is achieved. The overlap ratio can be calculated with the following formula:

Overlap ratio=(U−L)/control area, (1)

in which the control area is the overall control area and U and L are points at which the truth value μ=0. When the values of Tables 3 and 4 are used, an overlap ratio of 0.17 (=(0.08−0.07)/(0.13−0.07)) is obtained.

TABLE 5

| N_6 | N_5 | N_4 | N_3 | N_2 | N_1 | N | P_1 | P_2 | P_3 | P_4 | P_5 | P_6 |
|---|---|---|---|---|---|---|---|---|---|---|---|---|
| −1.2 | −1.0 | −0.8 | −0.6 | −0.4 | −0.2 | 0 | 0.2 | 0.4 | 0.6 | 0.8 | 1.0 | 1.2 |

Table 5 shows also the truth values corresponding to the control group of the control system according to a preferred embodiment of the present invention. The values of Table 5 show how much the index of the modulation mode changes in different situations. To calculate the change in this modulation mode, at first the packet error rate must be converted to a corresponding fuzzy control variable. This is exemplified by FIG. 2 corresponding to the set of curves in FIG. 1a, wherein a triangular D has also been drawn having an apex at a point corresponding to the true packet error rate (line C). This triangle D intersects the adjacent triangles (NS and Z) at certain points A, B. The probability values μᵢ, which correspond to these intersection points and in which i=1,2, can be used in the calculation of the modulation index for example according to the following formula:

$$d M o d e = {\sum }_{i = 1}^{2} {μ}_{i} \cdot L A B E L \qquad ( 2 )$$

in which LABEL is a value according to the fuzzy rules obtained on the basis of Tables 2 and 5. From Table 2 it is clarified the deviation of the target value of the selected packet error rate and the true packet error rate PER from the wished target value, and the controllable value according to the change rate of the packet error rate PERdt, whereafter Table 5 gives the truth value corresponding to the controllable value, which truth value is used as the variable LABEL in the afore-described formula (2). In the exemplified situation of FIG. 2 the control value is selected from the column NS, on the row that corresponds to the change rate of the packet error rate. If the change rate of the packet error rate is for example NM, the selected controllable value is P_{—}3. Consequently, the variable LABEL has the value 0.6. However, the index change of the modulation mode must be an integer, wherein the change dMode calculated in accordance with the formula is rounded to the nearest integer. The new modulation mode index is the sum of the old modulation mode index and the modulation mode change, represented in the formula:

Mode=Mode+dMode (3)

This rounding to an integer causes rounding errors, which can cause vibration in the impulse response of the system and so-called ringing, which should be compensated.

In the method according to a preferred embodiment of the invention, in order to minimize the vibration and ringing, information is maintained about the maximum modulation mode when the packet error rate PER is below a predefined limit, about the transmission power level related to this maximum modulation mode, and about the packet error rate.

Next in the method it is examined whether a packet error rate corresponding substantially to the desired packet error rate is obtained with the modulation mode selected according to the performed adjustment (block 304). If the packet error rate still differs significantly from said limit value, the modulation mode is set to correspond substantially to the above defined new modulation mode (block 305), wherein the settings corresponding to the modulation mode are advantageously implemented in accordance with Table 1. The afore-presented fuzzy control phases are repeated subsequently.

After the maximum modulation mode has been found in the initialising phase, the transmission power is set to a level in which the required packet error rate can be maintained (block 306). Fuzzy logic is advantageously applied also in this context. Correspondingly, the accompanying Table 6 presents the fuzzy rules applicable to this control of the transmission power level and Table 7 presents the truth values corresponding to the same.

TABLE 6

| PER | NL | NM | NS | Z | PS | PM | PL |
|---|---|---|---|---|---|---|---|
| μ = 1 | N_3 | N_2 | N_1 | N | P_1 | P_2 | P_3 |

TABLE 7

| N_3 | N_2 | N_1 | N | P_1 | P_2 | P_3 |
|---|---|---|---|---|---|---|
| 1 | 0.67 | 0.33 | 0 | −0.33 | −0.67 | −1 |

In the calculation of the transmission power level, the same principles can be applied as above in the selection of the modulation mode. The variable used is also here the packet error rate PER. Thus, the index change of the transmission power level can be calculated with the following formula:

$$d T x = {\sum }_{i = 1}^{2} {μ}_{i} \cdot L A B E L \qquad ( 4 )$$

in which

dTx=the index change of the transmission power level,

μⱼ=the value of the probabilities corresponding to the intersection points,

j=1, 2, and

LABEL=the truth value of the element.

In this case the change value dTx can also be rounded up to the nearest integer in order to change the index of the transmission power level. The new index of the transmission power level is obtained by summing up the old index of the transmission power level and the index change of the transmission power level calculated with the formula (4):

Tx=Tx+dTx (5)

The real power corresponding to the index of the transmission power level and set to the transmitter can be selected for example on the basis of Table 8.

The above-described adjustments are repeated during the connection, wherein the changes that may take place in the connection conditions can be taken into account by changing the modulation mode and/or the transmission power.

In the method according to a preferred embodiment of the invention, said maintained information, such as the maximum modulation mode, the transmission power level corresponding to the same, and the packet error rate, are set back to their default values. This is done in order to clarify whether it is possible to achieve an even faster data rate. If the modulation mode is changed in this situation, and the packet error rate, as a result of this, exceeds the predefined limit value, the control system of the invention readjusts itself back to the optimal state, in which the maximum modulation mode is used, by which the packet error rate can be kept below said limit value.

Another preferred embodiment of the method in accordance with the invention will be described with reference to FIG. 3b. In this embodiment, one of the applicable modulation modes and transmission powers is selected in the initialisation phase (block 307). The transmission power does not need to be the highest possible, but some other value can also be selected. During the operation, the packet error rate PER and the change rate of the packet error rate PERdt are defined (block 308). These defined values PER and PERdt are used as the input parameters of fuzzy control (block 309), according to which parameters the control is performed for example using Tables 5 and 7 (block 310). The control gives as result the modulation mode and the transmission power, which are used until the next control round has been performed and possibly another modulation mode and/or transmission power has been selected. In this embodiment, the modulation mode and the transmission power are controlled continuously, wherein information on the maximum modulation mode, in which the packet error rate remains substantially as high as or lower than the defined target value, does not need to be maintained in the system, nor information on the corresponding transmission power. Because both the modulation mode and the transmission power are controlled substantially simultaneously in this embodiment, more emphasis must be put on the selection of the control parameters in this embodiment compared to the above-described method according to the first preferred embodiment of the invention in order to minimize the vibration and ringing effect.

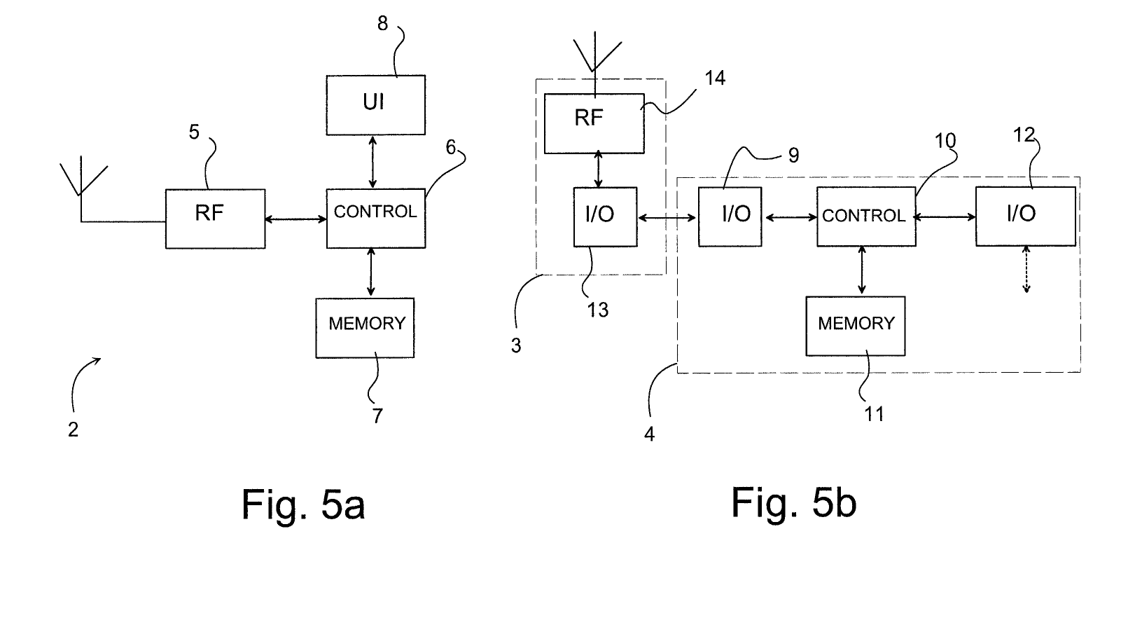

FIG. 5a illustrates, in a reduced block chart, a wireless terminal 2 in which the present invention can be applied. The wireless terminal 2 comprises advantageously a radio part 5 in order to perform, in a communication system, wireless communication with other equipment, such as the access point 4 and/or the wireless terminals 2. A control block 6 is used for controlling the operation of the wireless terminal 2. Memory means 7 are used for example for storing program codes required in the operation of the wireless terminal 2, and for storing of information during operation. The user interface 8 comprises advantageously, in a manner known as such, audio equipment, such as an earpiece and a microphone, a display and a keypad, which, however, are not illustrated in the appended figures.

FIG. 5b illustrates, in a reduced block chart, an access point controller 4 in which the present invention can also be applied. The access point controller 4 comprises first communication equipment 9 for communication with the access point 3. The access point 3 has corresponding communication equipment 13. Additionally, the access point controller 4 has a memory block 10 and memory means 11. The access point controller 4 can communicate through other communication equipment 12 with other access point controllers 4 and/or with other communication systems, such as with a public switched telephone network and/or a wireless telecommunication network. Radio communication with the wireless terminal 2 is performed with a radio part 14 arranged in the access point 3.

The present invention can be applied advantageously in the access point controller 4, which performs the above-described control functions on the basis of the signals received from the wireless terminal 2. The control phases according to the invention can, to a great extent, be implemented for example as a program code of the control block 10 of the access point controller 4. It is obvious, that the method according to the invention can also be applied in a wireless terminal 2. In addition, the application can be applied in such communication systems, in which none of the devices operates as the host, but each device connected to the communication system can have direct contact with any of the other devices connected to the communication system. Thus, every terminal can adapt the method of the invention in different terminal connections. The tables of fuzzy control required in the method can be stored advantageously into the memory means 7, 11 of the controlling device 2, 4.

It is obvious that the present invention is not limited solely to the above-presented embodiments, but it can be modified within the scope of the appended claims.

1. A method for performing link adaptation in a communication system, in which two communication devices are arranged to communicate with in order to transfer information at least partly wirelessly, packets are formed from the information to be transferred, the packet error rate is determined, and for which connection at least two different modulation modes can be selected, wherein the method uses fuzzy control in the selection of the modulation mode, and that at least one of the variables used in fuzzy control is said defined packet error rate.

2. The method according to claim 1, wherein in the method a target value is determined to the packet error rate, that the packet error rate is aimed to be kept substantially the same as the target value, and that the difference between the packet error rate and the target value is also used as a variable in the method.

3. The method according to claim 2, wherein for performing fuzzy control a first set of control values is formed, in which the packet error rate is used as a variable, a second set of control values is formed, in which the change rate of the packet error rate is used as a variable, and a set of fuzzy rules is arranged, which are used for determining the effect of the control values to the modulation mode used as a controllable value.

4. The method according to claim 3, wherein said control value sets are formed of the values: positive large, positive medium, positive small, negligible, not small, not medium, and not large.

5. The method according to claim 4, wherein said set of fuzzy rules is determined on the basis of the following table:

| | PER | | | | | | | |
|---|---|---|---|---|---|---|---|---|
| PERdt | | NL | NM | NS | Z | PS | PM | PL |
| | NL | P_6 | P_5 | P_4 | P_3 | P_2 | P_1 | N |
| | NM | P_5 | P_4 | P_3 | P_2 | P_1 | N | N_1 |
| | NS | P_4 | P_3 | P_2 | P_1 | N | N_1 | N_2 |
| | Z | P_3 | P_2 | P_1 | N | N_1 | N_2 | N_3 |
| | PS | P_2 | P_1 | N | N_1 | N_2 | N_3 | N_4 |
| | PM | P_1 | N | N_1 | N_2 | N_3 | N_4 | N_5 |
| | PL | N | N_1 | N_2 | N_3 | N_4 | N_5 | N_6 |

6. The method according to claim 5, wherein said first set of control values comprised the following values:

| PER | NL | NM | NS | Z | PS | PM | PL |
|---|---|---|---|---|---|---|---|
| μ = 1 | 0.07 | 0.08 | 0.09 | 0.10 | 0.11 | 0.12 | 0.13 |

that said second set of control values comprises the following values:

| PERdt | NL | NM | NS | Z | PS | PM | PL |
|---|---|---|---|---|---|---|---|
| μ = 1 | −0.006 | −0.004 | −0.002 | 0 | 0.002 | 0.004 | 0.006 |

and that said set of fuzzy controls comprises the following values:

| N_6 | N_5 | N_4 | N_3 | N_2 | N_1 | N | P_1 | P_2 | P_3 | P_4 | P_5 | P_6 |
|---|---|---|---|---|---|---|---|---|---|---|---|---|
| −1.2 | −1.0 | −0.8 | −0.6 | −0.4 | −0.2 | 0 | 0.2 | 0.4 | 0.6 | 0.8 | 1.0 | 1.2 |

7. The method according to claim 6, wherein in the method a set of modulation modes is defined, wherein for each modulation mode an individualizing index is defined, and in the method at least the following steps are taken:
an initialisation phase, wherein one of said indexes is selected in order to select the modulation mode used in the communication connection,
a computing phase, in which the difference of the packet error rate from the target value, and the change rate of the packet error rate are calculated, and
a fuzzy control phase, in which fuzzy control is used for defining the index change of the modulation mode, wherein the modulation mode according to the calculated new index is selected for the communication connection.

8. The method according to claim 7, wherein said calculating phase and the fuzzy control phase are repeated.

9. The method according to claim 1, wherein the transmission power is also controlled in the method.

10. The method according to claim 9, wherein in the method the modulation mode is adjusted until a such modulation mode is obtained, by which the packet error rate (PER) is substantially the same as said target value of the packet error rate, whereafter the transmission power is adjusted by using fuzzy control.

11. The method according to claim 9, wherein the modulation method and the transmission power are selected substantially simultaneously.

12. A communication system, comprising means for arranging two communication devices to communicate with each other in order to transfer packet-form information at least partly wirelessly, means for determining a packet error rate, and means for selecting for the connection a modulation mode from at least two modulation modes, wherein the communication system comprises means for using fuzzy control in the selection of the modulation mode, and that at least one variable arranged to be used in fuzzy control is the packet error rate.

13. The communication system according to claim 12, wherein a target value is defined for the packet error rate, that the means for the link adaptation comprise means for adjusting the packet error rate to substantially the same as said target value, and that the difference between the packet error rate and the result value is additionally arranged to be used as a fuzzy control variable.

14. The communication system according to claim 13, wherein for performing fuzzy control a first set of control values is formed, in which the packet error rate has been used as a variable, and a second set of control values, in which the change rate of the packet error rate has been used as a variable, and that a set of fuzzy rules has been formed for defining the influence of the control values of said variables to the modulation mode used as a controllable value.

15. An access point controller comprising means for arranging the access point controller and at least one wireless terminal to communicate with each other in order to transmit packet-form information at least partly in a wireless manner, means for defining the packet error rate, and means for selecting for the connection a modulation mode from at least two modulation modes, wherein the access point controller comprises means for using fuzzy control in the selection of the modulation mode, and that in fuzzy control at least one variable that is arranged to be used is said defined packet error rate.

16. A wireless terminal, comprising means for transmitting packet-form information at least partly wirelessly in a communication connection arranged between the wireless terminal and a second communication device, means for defining the packet error rate, and means for selecting for the connection a modulation mode from at least two modulation modes, wherein the wireless terminal comprises means for using fuzzy control in the selection of the modulation mode, and that in fuzzy control at least one variable that is arranged to be used is said defined packet error rate.
